(19) United States
(12) Patent Application Publication
(10) Pub. No.: US 2015/0033141 A1
(43) Pub. Date: Jan. 29, 2015

(54) SYSTEM AND METHOD FOR PROVIDING AN INTERACTIVE MESSAGE INBOX

(71) Applicant: YAHOO! INC., Sunnyvale, CA (US)

(72) Inventor: Gaurav Mishra, Cupertino, CA (US)

(73) Assignee: YAHOO! INC., Sunnyvale, CA (US)

(21) Appl. No.: 13/950,067

(22) Filed: Jul. 24, 2013

(51) Int. Cl. H04L 12/58

(52) U.S. Cl. CPC H04L 51/00
USPC 715/752

(57) ABSTRACT

Disclosed is a system and method for email management that leverages information associated with an incoming email message in order to organize the recipient's inbox and display relevant message content from the inbox. The present disclosure identifies messages by their relevance to a recipient, and effectively displays the relevant portions of the message to the recipient in an efficient manner which allows users to interact with the messages from the inbox. According to some embodiments, the present disclosure categorizes emails and provides a user interface for presenting the emails prioritized by importance or relevance to the recipient. The present disclosure logically categorizes incoming emails and displays enriched snippets extracted from the messages from the inbox without the user having to open the message, thereby allowing the user to view and/or interact with the message from the inbox.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to an email inbox management, and more particularly towards displaying electronic mail messages in an inbox with enhanced content derived from the email messages thereby allowing users to interact with the messages from the inbox.

### RELATED ART

Electronic mail (email) has become an increasingly popular mode of communication as larger numbers of people are able to access the Internet from an array of devices. In addition to providing a way for individuals to communicate more efficiently with each other, electronic mail also provides an effective form of communication for individuals, businesses, organizations, and other entities interested in communicating with large groups of people, such as friends, family, current and potential customers, and the like.

### SUMMARY

The present disclosure discloses a system and method for email management that leverages information associated with an incoming email message in order to organize the recipient's inbox and display relevant message content from the inbox. Conventional email platforms perform triage and simple sorting of emails. The present disclosure addresses the need to identify messages by their relevance to a recipient, and effectively display the relevant portions of the message to the recipient in an efficient manner which allows users to interact with the messages from the inbox. According to some embodiments, the present disclosure categorizes emails and provides a user interface for presenting the emails prioritized by importance or relevance to the recipient. Categorization can be based upon a variety of criteria, such as importance or relationship between the recipient and sending party/entity and/or email content. As discussed herein, the present disclosure logically categorizes incoming emails and displays enriched snippets extracted from the messages within the inbox without the user having to open the message, thereby allowing the user to view and/or interact with the message from the inbox.

In accordance with one or more embodiments, a method is disclosed which includes receiving, at a computing device over a network, a message from a first user addressed to a second user, said message comprising content and message metadata; parsing, via the computing device, the message metadata to extract an identifier associated with the first user, categorizing, via the computing device, the message based on the first user identifier, said categorizing comprising determining a message category corresponding to a message type associated with the first user identifier; determining, via the computing device, a message template associated with said message category, said message template comprising information for identifying relevant portions of said message type; comparing, via the computing device, the message template to the message content, said comparing comprising identifying first content from the message content based on said information in the message template; extracting, via the computing device, said first content from said message content; and facilitating, via the computing device, display of said first content in an inbox associated with the second user.

In accordance with one or more embodiments, a non-transitory computer-readable storage medium is provided, the computer-readable storage medium tangibly storing thereon, or having tangibly encoded thereon, computer readable instructions that when executed cause at least one processor to perform a method for displaying electronic mail messages in an inbox with enhanced content derived from the email messages thereby allowing users to interact with the messages from the inbox.

In accordance with one or more embodiments, a system is provided that comprises one or more computing devices configured to provide functionality in accordance with such embodiments. In accordance with one or more embodiments, functionality is embodied in steps of a method performed by at least one computing device. In accordance with one or more embodiments, program code to implement functionality in accordance with one or more such embodiments is embodied in, by and/or on a computer-readable medium.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating a client device in accordance with some embodiments of the present disclosure;

FIG. 3 is a representation of a conventional email inbox;

FIG. 4 illustrates a messaging engine in accordance with embodiments of the present disclosure;

FIG. 5 is a flowchart illustrating steps performed in accordance with an embodiment of the present disclosure;

FIGS. 6A-6B are examples of messages displayed in a recipient's inbox according to embodiments of the present disclosure; and

FIG. 7 is a block diagram illustrating architecture of a hardware device in accordance with one or more embodiments of the present disclosure.

### DESCRIPTION OF EMBODIMENTS

The present disclosure will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of a general purpose computer, special purpose computer, ASIC, or other programmable data processing apparatus, such that the instructions, which execute via the processor of the computer or other programmable data processing apparatus, implement the functions/acts specified in the block diagrams or operational block or blocks.

For the purposes of this disclosure a computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix. Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a system of terminals, gateways, routers, or the like coupled by wireless radio links, or the like, which may move freely, randomly or organize themselves arbitrarily, such that network topology may change, at times even rapidly. A wireless network may further employ a plurality of network access technologies, including Long Term Evolution (LTE), WLAN, Wireless Router (WR) mesh, or 2nd, 3rd, or 4th generation (2G, 3G, or 4G) cellular technology, or the like. Network access technologies may enable wide area coverage for devices, such as client devices with varying degrees of mobility, for example.

For example, a network may enable RF or wireless type communication via one or more network access technologies, such as Global System for Mobile communication (GSM), Universal Mobile Telecommunications System (UMTS), General Packet Radio Services (GPRS), Enhanced Data GSM Environment (EDGE), 3GPP Long Term Evolution (LTE), LTE Advanced, Wideband Code Division Multiple Access (WCDMA), Bluetooth, 802.11b/g/n, or the like. A wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

For purposes of this disclosure, a client (or consumer or user) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device an Near Field Communication (NFC) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. Claimed subject matter is intended to cover a wide range of potential variations. For example, a cell phone may include a numeric keypad or a display of limited functionality, such as a monochrome liquid crystal display (LCD) for displaying text. In contrast, however, as another example, a web-enabled client device may include one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

A client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook®, LinkedIn®, Twitter®, Flickr®, or Google+®, Instagram™, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

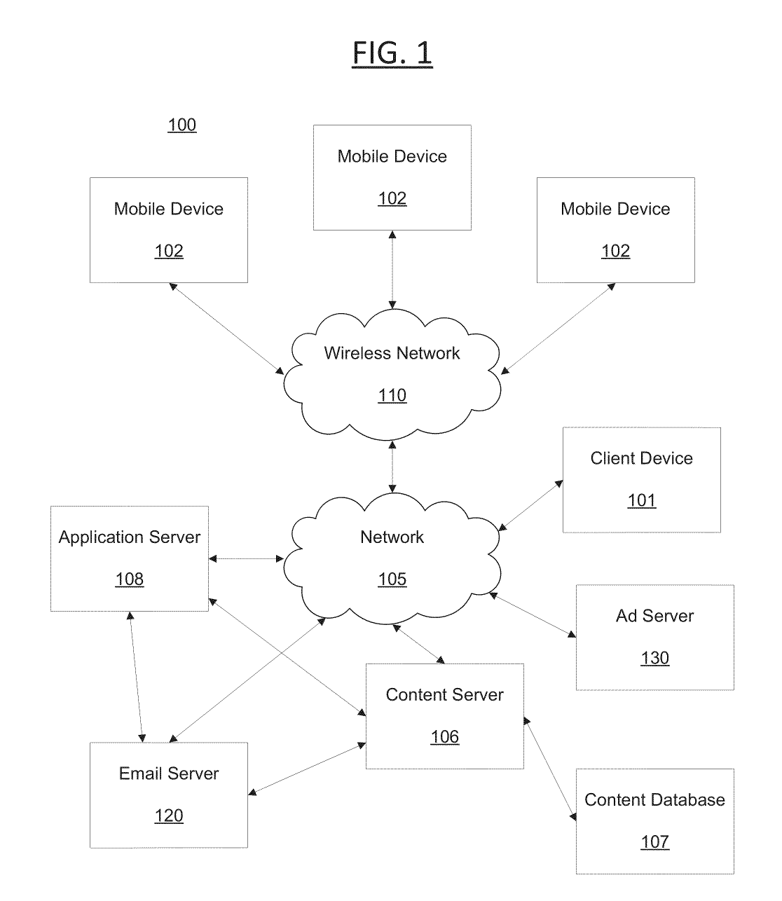

The principles described herein may be embodied in many different forms. Certain embodiments will now be described in greater detail with reference to the figures. In general, with reference to FIG. 1, a system 100 in accordance with an embodiment of the present disclosure is shown. FIG. 1 shows components of a general environment in which the systems and methods discussed herein may be practiced. Not all the components may be required to practice the disclosure, and variations in the arrangement and type of the components may be made without departing from the spirit or scope of the disclosure. As shown, system 100 of FIG. 1 includes local area networks (“LANs”)/wide area networks (“WANs”)—network 105, wireless network 110, mobile devices (client devices) 102-104 and client device 101. FIG. 1 additionally includes a variety of servers, such as content server 106, application (or “App”) server 108, email server 120 and advertising (“ad”) server 130.

One embodiment of mobile devices 102-103 is described in more detail below. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include multi-touch and portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message.

Mobile devices 102-104 also may include at least one client application that is configured to receive content from another computing device. The client application may include a capability to provide and receive textual content, graphical content, audio content, and the like. The client application may further provide information that identifies itself, including a type, capability, name, and the like. In one embodiment, mobile devices 102-104 may uniquely identify themselves through any of a variety of mechanisms, including a phone number, Mobile Identification Number (MIN), an electronic serial number (ESN), or other mobile device identifier.

In some embodiments, mobile devices 102-104 may also communicate with non-mobile client devices, such as client device 101, or the like. In one embodiment, such communications may include sending and/or receiving messages, share photographs, audio clips, video clips, or any of a variety of other forms of communications. Client device 101 may include virtually any computing device capable of communicating over a network to send and receive information. The set of such devices may include devices that typically connect using a wired or wireless communications medium such as personal computers, multiprocessor systems, microprocessor-based or programmable consumer electronics, network PCs, or the like. Thus, client device 101 may also have differing capabilities for displaying navigable views of information.

Client devices 101-104 computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Wireless network 110 is configured to couple mobile devices 102-104 and its components with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly. Wireless network 110 may further employ a plurality of access technologies including 2nd (2G), 3rd (3G), and/or 4th (4G) generation radio access for cellular systems. WLAN, Wireless Router (WR) mesh, and the like. Access technologies such as 2G, 3G, 4G and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Network 105 is configured to couple content server 106, application server 108, or the like, with other computing devices, including, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between content servers 106, application server 108, client device 101, and/or other computing devices.

Within the communications networks utilized or understood to be applicable to the present disclosure, such networks will employ various protocols that are used for communication over the network. Signal packets communicated via a network, such as a network of participating digital communication networks, may be compatible with or compliant with one or more protocols. Signaling formats or protocols employed may include, for example, TCP/IP, UDP, DECnet, NetBEUI, IPX, APPLETALK™, or the like. Versions of the Internet Protocol (IP) may include IPv4 or IPv6. The Internet refers to a decentralized global network of networks. The Internet includes local area networks (LANs), wide area networks (WANs), wireless networks, or long haul public networks that, for example, allow signal packets to be communicated between LANs. Signal packets may be communicated between nodes of a network, such as, for example, to one or more sites employing a local network address. A signal packet may, for example, be communicated over the Internet from a user site via an access node coupled to the Internet. Likewise, a signal packet may be forwarded via network nodes to a target site coupled to the network via a network access node, for example. A signal packet communicated via the Internet may, for example, be routed via a path of gateways, servers, etc. that may route the signal packet in accordance with a target address and availability of a network path to the target address.

According to some embodiments, the present disclosure may also be utilized within a social networking site. A social network refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. In some embodiments, multi-modal communications may occur between members of the social network. Individuals within one or more social networks may interact or communication with other members of a social network via a variety of devices. Multi-modal communication technologies refers to a set of technologies that permit interoperable communication across multiple devices or platforms, such as cell phones, smart phones, tablet computing devices, personal computers, televisions, set-top boxes, SMS/MMS, email, instant messenger clients, forums, social networking sites, or the like.

In some embodiments, the disclosed networks 110 and/or 105 may comprise a content distribution network(s). A “content delivery network” or “content distribution network” (CDN) generally refers to a distributed content delivery system that comprises a collection of computers or computing devices linked by a network or networks. A CDN may employ software, systems, protocols or techniques to facilitate various services, such as storage, caching, communication of content, or streaming media or applications. A CDN may also enable an entity to operate or manage another's site infrastructure, in whole or in part.

The content server 106 may include a device that includes a configuration to provide content via a network to another device. A content server 106 may, for example, host a site, such as an email platform or social networking site, or a personal user site (such as a blog, vlog, online dating site, and the like). A content server 106 may also host a variety of other sites, including, but not limited to business sites, educational sites, dictionary sites, encyclopedia sites, wikis, financial sites, government sites, and the like. Devices that may operate as content server 106 include personal computers desktop computers, multiprocessor systems, microprocessor-based or programmable consumer electronics, network PCs, servers, and the like.

Content server 106 can further provide a variety of services that include, but are not limited to, email services, photo services, web services, third-party services, audio services, video services, email services, instant messaging (IM) services, SMS services, MMS services, FTP services, voice over IP (VOIP) services, or the like. Such services, for example the email services and email platform, can be provided via the email server 120. Examples of content may include images, text, audio, video, or the like, which may be processed in the form of physical signals, such as electrical signals, for example, or may be stored in memory, as physical states, for example.

An ad server 130 comprises a server that stores online advertisements for presentation to users. “Ad serving” refers to methods used to place online advertisements on websites, in applications, or other places where users are more likely to see them, such as during an online session or during computing platform use, for example. Various monetization techniques or models may be used in connection with sponsored advertising, including advertising associated with user. Such sponsored advertising includes monetization techniques including sponsored search advertising, non-sponsored search advertising, guaranteed and non-guaranteed delivery advertising, ad networks/exchanges, ad targeting, ad serving and ad analytics.

For example, a process of buying or selling online advertisements may involve a number of different entities, including advertisers, publishers, agencies, networks, or developers. To simplify this process, organization systems called “ad exchanges” may associate advertisers or publishers, such as via a platform to facilitate buying or selling of online advertisement inventory from multiple ad networks. “Ad networks” refers to aggregation of ad space supply from publishers, such as for provision en masse to advertisers. For web portals like Yahoo!®, advertisements may be displayed on web pages resulting from a user-defined search based at least in part upon one or more search terms. Advertising may be beneficial to users, advertisers or web portals if displayed advertisements are relevant to interests of one or more users. Thus, a variety of techniques have been developed to infer user interest, user intent or to subsequently target relevant advertising to users. One approach to presenting targeted advertisements includes employing demographic characteristics (e.g., age, income, sex, occupation, etc.) for predicting user behavior, such as by group. Advertisements may be presented to users in a targeted audience based at least in part upon predicted user behavior(s). Another approach includes profile-type ad targeting. In this approach, user profiles specific to a user may be generated to model user behavior, for example, by tracking a user's path through a web site or network of sites, and compiling a profile based at least in part on pages or advertisements ultimately delivered. A correlation may be identified, such as for user purchases, for example. An identified correlation may be used to target potential purchasers by targeting content or advertisements to particular users. During presentation of advertisements, a presentation system may collect descriptive content about types of advertisements presented to users. A broad range of descriptive content may be gathered, including content specific to an advertising presentation system. Advertising analytics gathered may be transmitted to locations remote to an advertising presentation system for storage or for further evaluation. Where advertising analytics transmittal is not immediately available, gathered advertising analytics may be stored by an advertising presentation system until transmittal of those advertising analytics becomes available.

Servers 106, 108, 120 and 130 may be capable of sending or receiving signals, such as via a wired or wireless network, or may be capable of processing or storing signals, such as in memory as physical memory states. Devices capable of operating as a server may include, as examples, dedicated rack-mounted servers, desktop computers, laptop computers, set top boxes, integrated devices combining various features, such as two or more features of the foregoing devices, or the like. Servers may vary widely in configuration or capabilities, but generally, a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

In an embodiment, users are able to access services provided by servers 106, 108, 120 and/or 130. This may include in a non-limiting example, email servers, social networking services servers, SMS servers, IM servers, MMS servers, exchange servers, photo-sharing services servers, and travel services servers, via the network 105 using their various devices 101-104. In some embodiments, applications, such as a photo-sharing or viewing application (e.g., Flickr®, Instagram®, and the like), can be hosted by the application server 108. Thus, the application server 108 can store various types of applications and application related information including application data and user profile information. In another example, email server 120 can host email applications; therefore, the email server 120 can store various types of applications and application related information including email application data and user profile information. It should also be understood that content server 106 can also store various types of data related to the content and services provided by content server 106 in an associated content database 107, as discussed in more detail below. Embodiments exist where the network 105 is also coupled with/connected to a Trusted Search Server (TSS) which can be utilized to render content in accordance with the embodiments discussed herein.

Moreover, although FIG. 1 illustrates servers 106, 108, 120 and 130 as single computing devices, respectively, the disclosure is not so limited. For example, one or more functions of servers 106, 108, 120 and/or 130 may be distributed across one or more distinct computing devices. Moreover, in one embodiment, servers 106, 108, 120 and/or 130 may be integrated into a single computing device, without departing from the scope of the present disclosure.

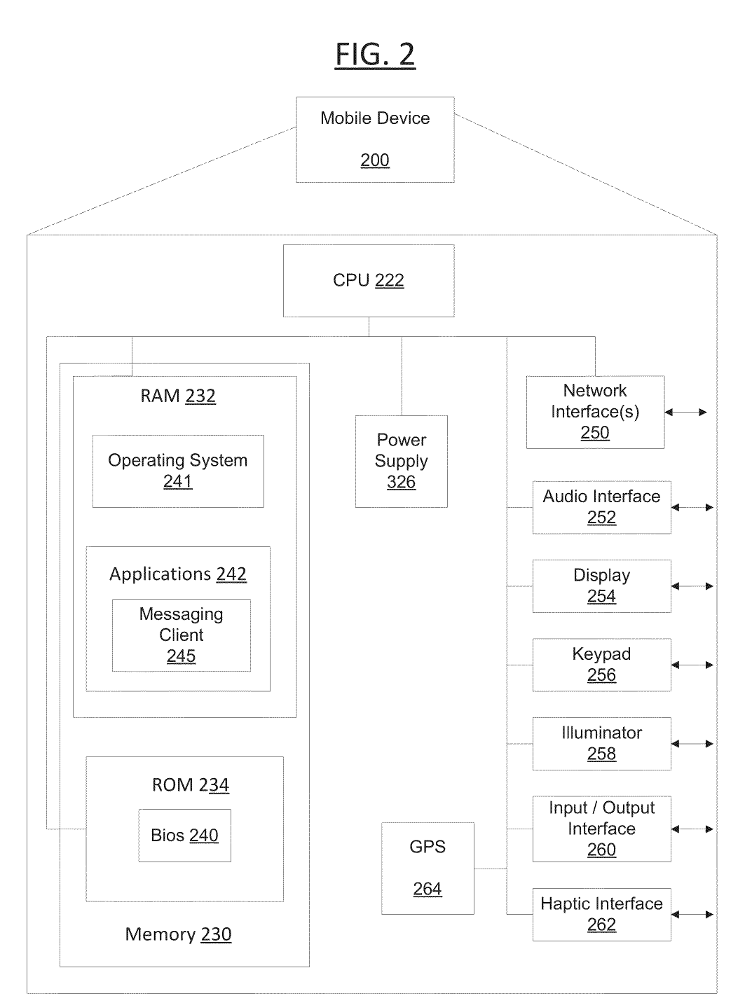

FIG. 2 is a schematic diagram illustrating a client device showing an example embodiment of a client device that may be used within the present disclosure. Client device 200 may include many more or less components than those shown in FIG. 2. However, the components shown are sufficient to disclose an illustrative embodiment for implementing the present disclosure. Client device 200 may represent, for example, client devices discussed above in relation to FIG. 1.

As shown in the figure, Client device 200 includes a processing unit (CPU) 222 in communication with a mass memory 230 via a bus 224. Client device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to Client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling Client device 200 to one or more networks, and is constructed for use with one or more communication protocols and technologies including, but not limited to, global system for Client communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate client device 200 in a particular way when the Client device 200 receives a communication from another user.

Optional GPS transceiver 264 can determine the physical coordinates of Client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of Client device 200 on the surface of the Earth. It is understood that under different conditions, GPS transceiver 264 can determine a physical location within millimeters for Client device 200; and in other cases, the determined physical location may be less precise, such as within a meter or significantly greater distances. In one embodiment, however, Client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of Client device 200. The mass memory also stores an operating system 241 for controlling the operation of Client device 200. It will be appreciated that this component may include a general purpose operating system such as a version of UNIX, or LINUX™, or a specialized client communication operating system such as Windows Client™, or the Symbian® operating system. The operating system may include, or interface with a Java virtual machine module that enables control of hardware components and/or operating system operations via Java application programs.

Memory 230 further includes one or more data stores, which can be utilized by Client device 200 to store, among other things, applications 242 and/or other data. For example, data stores may be employed to store information that describes various capabilities of Client device 200. The information may then be provided to another device based on any of a variety of events, including being sent as part of a header during a communication, sent upon request, or the like. At least a portion of the capability information may also be stored on a disk drive or other storage medium (not shown) within Client device 300.

Applications 242 may include computer executable instructions which, when executed by Client device 200, transmit, receive, and/or otherwise process audio, video, images, and enable telecommunication with another user of another client device. Other examples of application programs include calendars, browsers, contact managers, task managers, transcoders, database programs, word processing programs, security applications, spreadsheet programs, games, search programs, and so forth. Applications 242 may further include messaging client 245 that is configured to send, to receive, and/or to otherwise process messages using SMS, MMS, IM, email, VOIP, and/or any of a variety of other messaging communication protocols. Although a single messaging client 245 is illustrated it should be clear that multiple messaging clients may be employed. For example, one messaging client may be configured to manage SMS messages, where another messaging client manages IM messages, and yet another messaging client is configured to manage serving advertisements, emails, or the like.

Having described the components of the general architecture employed within the disclosed systems and methods, the components' general operation with respect to the disclosed systems and methods will now be described.

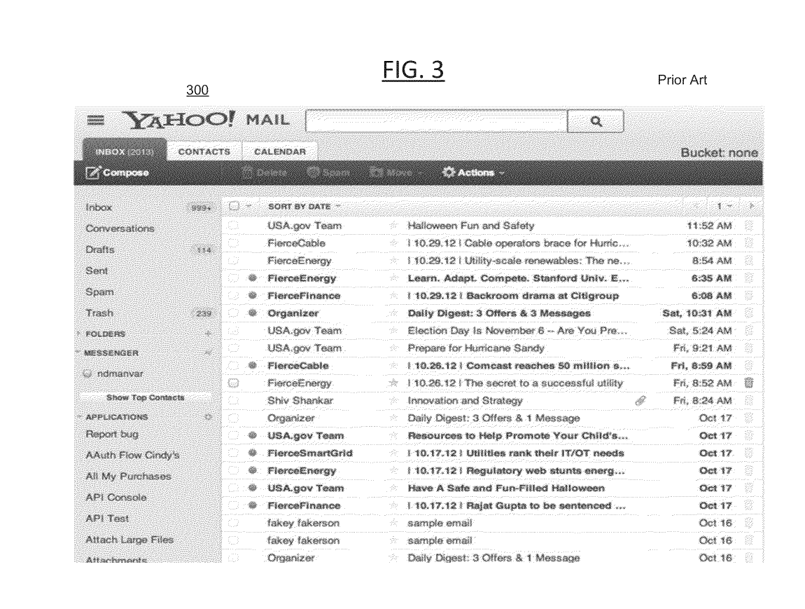

FIG. 3 illustrates a conventional email inbox 300. The inbox 300 displays each email message as a single line of text that typically includes the email sender, subject line, date, and size. The messages in the inbox are conventionally presented in the inbox 300 as a random mixture of important emails, personal communications from friends or family, neutral messages from safe senders, articles, advertisements, junk mail, and the like. Users generally make a manual pass through emails attempting to pick out the messages that contain the most important items that should receive immediate attention, and simultaneously sifting out irrelevant items. Additionally, some message platforms allow a user to set rules that can automatically tag or categorize messages. Further, current processing and triaging of inboxes are typically based on the subject line of the emails, which are often misleading, cryptic, or absent. For example, an email titled “your credit card statement” could be a bona fide notification from your credit card company, or an advertising spam message. However, the current sorting process is faulty as it fails to address the importance of providing relevant messages to the user in a convenient manner. Additionally, there is no current system that allows a user to view and/or interact with content of a message from the inbox, without opening the message.

Generally, the described systems and methods address these issues by allowing a recipient of an incoming message to view and/or interact with a message from the inbox, rather than the user having to open the message in order to perform such actions. As discussed above, traditional implementations and improvements regarding email/message inbox and management have centered on helping with “triage” and “removing clutter” in a user's inbox. Also, conventional inbox platforms and email providers have focused upon removing “unimportant” email away from a user's inbox in order to display a “cleaner” inbox. Most users dislike the idea of an email provider managing the flow of their email, as users typically visit their spam folder to check if any messages were relocated there improperly.

The disclosed systems and methods create a “stream” within a recipient's inbox by providing differential treatment to each email. This ensures that each message is allocated its appropriate importance and treatment regarding messages received from, i.e., friends or family. Additionally, messages having desired content, such as pictures or other content from friends and family are treated with higher importance. In some embodiments, the present disclosure allocates a reduced treatment to “coupons” or “deals” received from third party vendors.

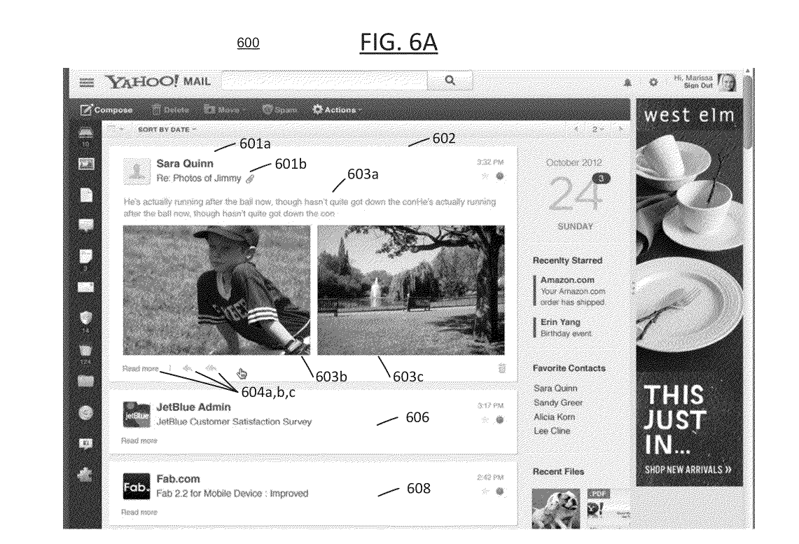

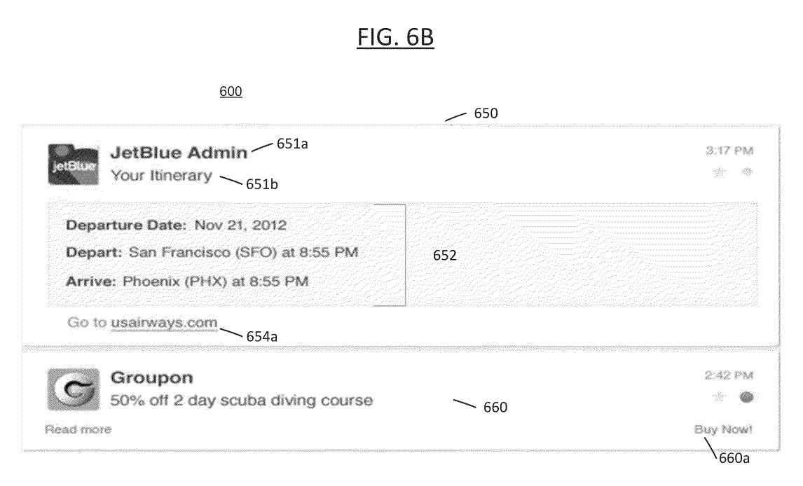

As such, the present disclosure addresses at least two problems currently effecting current users' message inboxes. First, the present disclosure provides a user with the ability to interact with emails from the inbox. Secondly, users are afforded the ability to browse content of received emails without having to click on the messages in the inbox and open them. As discussed above, and below in more detail, each message is given differential treatment, which is visibly effectuated in a user's inbox. For example, messages that are categorized as “Personal” are given preferential treatment to those messages categorized as “Shopping” or “Coupons.” Thus, messages that are of lower relevance to a user can be de-emphasized in the inbox. An example of such de-emphasis is that the messages of lower relevance or importance to a user may occupy a smaller amount of space within the inbox, as depicted in FIG. 6A where a “Personal” email is of higher importance to a “Travel” email, and thereby occupies a larger space within the inbox. Additionally, messages of lower importance may be situated lower in the user's inbox, thereby increasing the likelihood that the higher important or relevant emails will be viewed, also depicted in FIG. 6A, where the “Personal” message is located in the inbox above the “Travel” email and “Coupon” email.

Thus, the present disclosure provides for a much better user engagement with email. That is, based on the differential approach to categorized messages, the number of replies and messages received from “trusted” or “safe” senders will significantly increase. For example, one of the key engagement metrics for emails is the number of replies sent daily. The present disclosure impacts that number by allowing for effective, simple and efficient ways for a recipient of a message to identify the context of the message, and provide a response. Increased number of replies leads to higher quality of “incoming” messages, which ultimately leads to a secondary impact of a higher number of “non-spam” emails.

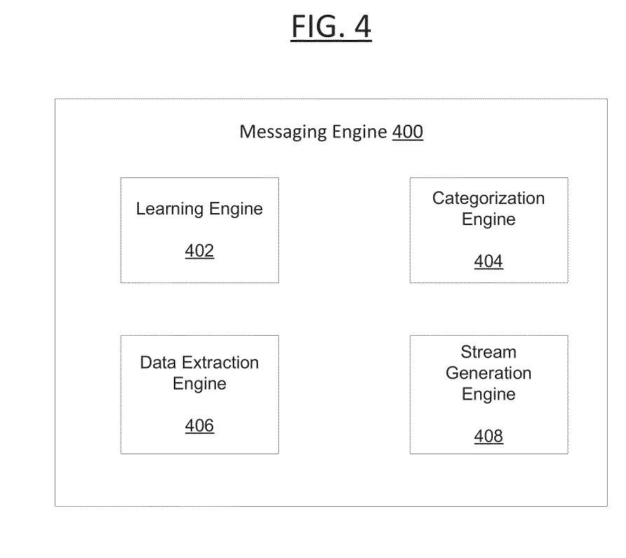

FIG. 4 illustrates a messaging engine 400 for performing the systems and methods discussed herein. The messaging engine 400 is implemented to categorize messages according to the relevance of the user, and ultimately effectuates display of relevant portions of the message content as a “stream” within the user's inbox. As discussed in more detail below, a “stream” is a message snippet (or preview) generated from structured data extracted from an email message. The stream is an enriched view of the email. That is, relevant portions of the message and relevant actions responsive to the message are displayed and/or provided to the user. For example, for a message from user A to his mother regarding pictures of user A's new born baby, the mother's inbox could show within the stream a thumbnail of the attached picture, and the capability of the mother to open the thumbnail image and respond to the message all from her inbox. Thus, a “stream” provides an interactive “snippet” of the email message in a recipient's inbox.

The messaging engine 400 comprises a learning engine 402, a categorization engine 404, a data extraction engine 406, and a stream engine 408 (or stream generation engine). It should be understood that the engines discussed here respective the messaging engine 400 are non-exhaustive, as additional or fewer engines may be applicable to the embodiments of the systems and methods discussed herein. In some embodiments, the messaging engine 400 could be hosted by a web server, a content provider or user computing device.

The learning engine 402 is configured to analyze all incoming messages received via the messaging platform, e.g., Yahoo! Mail®. The analysis of the messages includes parsing and identifying metadata associated with the messages, and message content. In some embodiments, the learning engine 402 analyzes a global set of messages and compiles information from a global scale within the messaging platform. In some embodiments, the learning module analyzes message communications per user (or recipient). Additionally, in some embodiments, the learning engine 402 has access to each user's contact list (or address book) and/or profile (which can include information regarding a user's frequently contacted parties that are not in the user's contact list). This information can be necessary in compiling certain categories of messages for specific users, where, for example, certain users are pre-classified within a user's profile. For example, user A has a contact list of user B and user C. User B is user A's brother, therefore he is classified (or categorized within the contact list/profile) as “family.” User C is user A's boss at work, therefore user C is classified as “co-worker.” Thus, as discussed below, User B's emails will be categorized as “Personal” from the “family” designation; and User C's will be categorized as “Business” based on the “co-worker” designation.

In some embodiments, the analysis of incoming messages occurs over a predetermined time period set by the message/content provider, system, a user, or combination thereof. In some embodiments, the learning engine 402 is continuously parsing and analyzing message data (e.g., message content and message metadata) to perform real-time or near-real time (or batched at time intervals) categorization and extraction, as discussed below. The information compiled by the learning engine 402 is stored in an index (in a data store or lookup table) associated with the messaging engine 400.

Based on the identified information within the messages, the learning engine 402 can build (and/or continuously update) sender categories and an associated email template directory. A sender category is utilized to categorize emails based on the sender of the message's address (or identifier, such as, but not limited to the sender's email address, telephone number, fax number, IP address, and any other known or to be known addresses/identifiers within a communications network). That is, the learning engine 402 can learn behaviors and tendencies of messages based on an email address, based at least in part upon the username and/or domain of email addresses. For example, the learning engine 402 can compile and deduce that a message from JetBlue Airways, e.g., “info@jetblue.com” should be categorized as “Travel.” In another example, an email from Groupon®, e.g., “deals@groupon.com” should be categorized as “Shopping” (or “Coupons”). In another example, a message sent to recipient James from his wife Eve would be categorized as “Personal.” This personal designation is, from the above discussion, based on Eve's email address being within James' contact list (since they are married). Therefore, the learning engine 402 compiles sender category information for categories of emails on a continuous basis in order to provide up-to-date categorical designations within the scope of the present disclosure. Examples of types of categories may include, but are not limited to, business email, service provider emails, personal emails from senders on the user's contact list, mail from entities recognized as safe (e.g., mail sent from organizations the user has recognized as “safe” by adding the organizations to their safe list), mail set to discussion “mail” lists or pulled automatically via RSS news feeds or other aggregation services, and other mail including junk mail and spam. Thus, it should be understood by those of ordinary skill in the art that there can be any array of categories from emails; therefore, for simplicity, particular categories for discussion purposes only are as follows: “Personal,” “Shopping,” “Social,” “Finance,” “Travel”. Indeed, it should be understood that the categories discussed herein are non-limiting and should not be construed to limit how certain emails are categorized, as they are illustrative to show the functionality of the systems and methods discussed herein.

The learning engine 402 also builds and updates email templates which are associated with the sender categories. This information is derived from the message content. That is, most emails from specific senders follow the same format. For example, messages from travel sites, merchants, social sites, finance institutions, and the like follow a standard template. The learning engine 402, after identifying the sender of an email, and categorizing the message based on the sender, then extracts the format of the email in order to build a template for the message category. In some embodiments, the template can be used to identify “key words,” or “hot words” that are typically utilized in types of messages within each message category. The template identifies the most relevant information is to the user. For example, an email from JetBlue Airways: travel@jetblue.com, typically involves a user's travel itinerary. Therefore, the learning engine 402, after identifying that the email is categorized as “Travel” from the sender's address, parses the message content and identifies where the relevant portions of the email are. From this, a “Travel” template is build. Therefore, upon receiving another email from a travel site, the messaging engine 400 can apply the “Travel” template to extract the relevant portions in order to build the stream, as discussed in more detail below.

The learning module 402 can employ categorizers using logistic regression or learning models including support vector machines (SVMs) to parse, identify, extract and map the message information as discussed above. It should be understood that known or to be known learning algorithms and models that analyze data and recognize patterns for classification and regression analysis can be utilized in accordance with the present disclosure.

The categorization engine 404 implements the data “learned” by the learning engine 402 in order to categorize messages received for a recipient based on the sender's address, as discussed above. For example, recipient A receives a message from his mother and a message confirmation for the flight itinerary he has just booked. Thus, the message from his mother would be categorized as “Personal,” as it would be understood from the learning engine's 402 development that most messages from a relative should be personal. In a similar manner, messages received from a travel site, such as Kayak.com, would be regarded as “Travel.” As discussed above, the message categorization is based at least in part upon the sender's address. Therefore, based on user profile data (e.g., address book) from recipient A, his mother would be readily identified as “Personal.” In some embodiments, the categorization engine 404 also will weigh the categories so that upon display of the message, it could have higher priority. For example, between messages categorized as “Personal” and “Shopping,” the personal messages could be weighted more heavily than the shopping messages. Thus, the personal messages could be displayed higher in the user's inbox, and/or be displayed at a bigger proportion to the inbox interface than that of the shopping message. Embodiments of this will be discussed in more detail below and illustrated in FIGS. 6A-6B.

The data extraction engine 406 is configured to extract data from the categorized messages based on the templates constructed by the learning engine 402. That is, the extraction is based upon the message type within a category for which the message is classified. From this, the template associated with the category is applied to the message in order to extract the relevant/important information from the message. For example, if the message is related to “Travel,” then the extraction will be related to the itinerary for travel. For example, Bob is travelling to New York on Dec. 1, 2013 from LAX on Virgin Airlines. This information is relayed to Bob in an email message from Virgin Airlines after Bob has booked his tickets online. Thus, the message is categorized as “Travel,” and the data extracted will be related towards his itinerary: LAX to EWR, Dec. 1, 2013 (another example illustrated in FIG. 6B). As discussed above, the extraction implemented by the data extraction module is also based upon associated categorical templates which are applicable from knowing the category of message. From the above example, most messages within a category have a similar layout. This information can be compiled from the learning engine 402. Thus, the travel message to Bob will have a similar format, and data extraction can be based upon the known (or learned format).

The stream engine 408 is configured to build and display the “snippet” of information from the message based on the extracted data. From the above example involving Bob's travel plans, along with the message indication that Bob has an email from Virgin Airlines, a stream of the message will be displayed in Bob's inbox providing the relevant travel information. Additionally, the stream engine 408, based on the category of message, also enables Bob to interact with the message, referred to as “call to action.” The calls to action are based upon the type of email, in that certain categories of emails will have streams allowing the user to perform certain actions, whereas other emails will not, or will have other functionality available to the user from the stream. For example, since the message involves travel plans, the stream for the message could enable Bob, via the “call to action”, to “check-in” to his flight. Therefore, Bob would be able to view the important content of the message, and interact with the relevant content without having to open the message. Thus, the messaging engine 400 effectuates the ability for a user to interact with emails from the inbox and affords the user the ability to browse content of received emails without having to click on the messages in the inbox and open them.

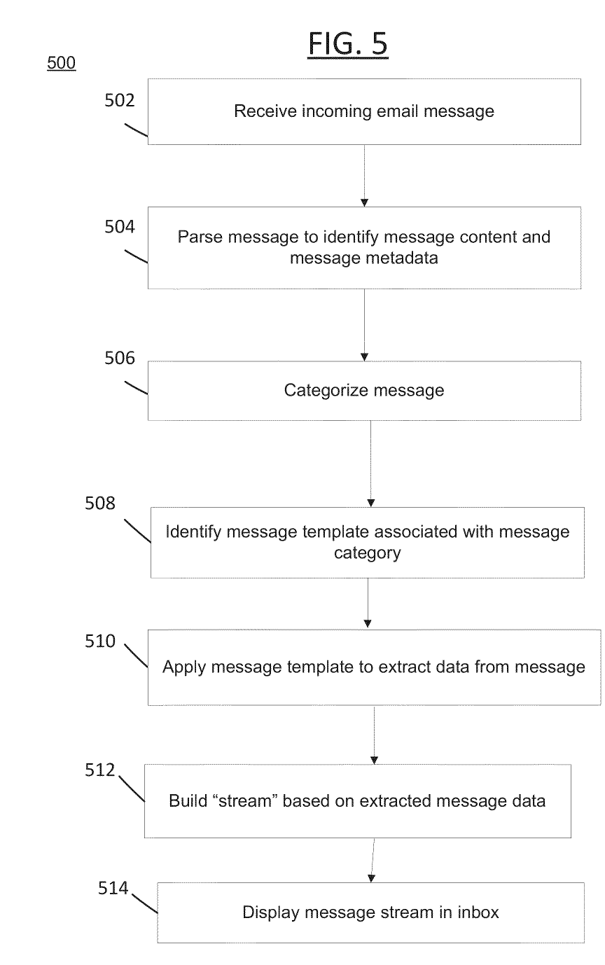

FIG. 5 depicts a flowchart illustrating the process 500 for implementing the messaging engine 400 of FIG. 4. As discussed above, the learning engine 402 continually analyzes messages communicated via the message platform, e.g., Yahoo! Mail®. That is, in some embodiments, the learning engine 402 continuously analyzes all messages sent and received via the message platform in order to learn behaviors of messages revolving around sender addresses, message content, and all other message content and metadata. Generally, process 500, based on the compilations of the learning engine 402 (and messaging engine 400), categorizes messages according to relevance of the user, and displays relevant portions of the message content as a “stream” in the user's inbox. Embodiments discussed herein involve electronic mail messages (referred to as “email”); however, it should not be construed as limiting to only those types of messages, as embodiments exist for receiving, processing, handling and displaying all types of known or to be known messages, such as, but not limited to, instant messages (IM), SMS messages, MMS messages, Twitter® messages, Facebook® messages, and all other types of social and communications messages, and the like. The operations of Process 500 may be performed by hardware, software executing on hardware, or combinations thereof, by the exemplary messaging engine 400.

In Step 502, a message is received for a user. For explanatory purposes, the process 500 will be discussed with reference to an example in order to better explain how the process is being performed. Therefore, as in Step 502, message recipient James is sent a message from Scott. In Step 504, the message is analyzed by the categorization engine 404, as discussed above. That is, the message is parsed in order to identify the metadata associated with the message. Specifically, the parsing of the message includes identifying the sender's email address. Here, for example, Scott's email is: scott@email.com. In some embodiments, the message content will also be analyzed.

In Step 506, the categorization engine 404 categorizes the message based on the identification of the sender's email address. That is, a message category is selected from the learned categories (from the learning engine 402) based on the sender's email address, as discussed above. In one example, Scott is James' brother, and his address is in James' contact list. Therefore, the categorization engine identifies Scott's email address, and classifies (or designates) the message as “Personal,” due to Scott's address appearing in the contact list of James, and the knowledge that James and Scott are brothers (compiled from the profile of James). In another example diverting from the James-Scott example, James receives an email from Macy's offering him a coupon. Here, the message is from: offer@macys.com. Since Macy's email address is not in James contact list, and the learning engine 402 has previously compiled information indicating that messages from merchants such as Macy's relate towards shopping, the message will be categorized as “Shopping.”

After categorization of the message, the next step in the process includes identifying the category template associated with the identified category. Step 508. Here, from the above James-Scott example, the message was identified as “Personal”. Therefore, the template associated with “Personal” email messages is identified. In the James-Macy's example from above, since the email was categorized as “Shopping,” the template associated with the category “Shopping” is identified. As discussed above, upon building the templates associated with categories, the learning engine 402 stores the categories and associated templates in an index (or datastore or lookup table). Thus, after identifying the category, the associated template is readily identifiable.

In Step 510, the data extraction engine 406 applies the template to the message received in Step 502. The application of the template is to identify and extract the relevant portions of the email message. From the above example involving James-Scott, the message was “Personal” and the appropriate/associated template was identified. Now, the “Personal” template is applied to the email (i.e., email content). Here, it is understood that the learning engine 402 has parsed and identified past personal emails from other users, as well as such emails to James. Additionally, personal emails typically follow a similar format, such as including the greeting, memo in the email, and the sign-off (or farewell). Therefore, the “Personal” message is extracted in accordance with the “Personal” template. It should be understood that there can be sub-categories of templates which are identifiable and applicable to certain email messages. For example, some personal messages are from friends and some are from family. Therefore, these messages may follow a different format. In another example, some “Business” emails may be from company 1 and company 2. In some embodiments, categories and associated templates can be created for specific companies or types of businesses.

In another example, some templates may be identified based on the content of the message. That is, should the categorization engine 404 identify that the received “Personal” message comprises attachments, e.g., pictures, the data extraction engine 406 may identify (or select) a “Personal” template that could be used to extract not only the message text, but also the multi-media (e.g., pictures or images). For example, as illustrated in FIG. 6A, in inbox 600 is displayed a message stream from ‘Sara Quinn’ 602. Traversing the above steps, the message was identified as “Personal” (based on either Sara being in James' contact list, or the content of the message comprising mention of James' son Jimmy). Next, the categorization engine 404 identified the proper template for the “Personal” category. This template would need to have the ability to recognize and extract images attached to, or contained within the message. As discussed in more detail below in the following steps, the relevant content was extracted (item 603a), as were the images (items 603b, 603c).

After the relevant/important data (or content) has been extracted from the received message, the stream engine 408 generates the stream for display in the recipient's inbox. Step 512. As discussed above, a “stream” is a snippet of content from the message that relates to the most relevant/important content in the message. That is, relevant portions of the message and relevant actions responsive to the message are displayed and/or provided to the user. Thus, the stream is generated from the result of the data extraction engine 406. That is, the data extracted in Step 510 is collected and utilized to generate a snippet for display in the recipient's inbox. This snippet can also be referred to as a “preview” of the message. The snippet (or preview) is displayed in a frame or region of the inbox along with the other identifying information of the message. That is, as illustrated in FIG. 6A, conventionally a new message 602 comprises the sender's identity 601a, and title of the email 601b (as discussed above also in relation to FIG. 3). The steam (or snippet or preview) also comprises the relevant content of the message 603a (and attachments as thumbnails: 603b, 603c). In some embodiments, an advertisement can be served based on the extraction and categorization steps discussed above. That is, an advertisement can be selected based on the extracted data used to generate the stream. As a whole, the advertisement can be served based upon information within the received messages, displayed snippet, or user profile information, or any combination thereof. The displayed advertisement can be displayed as a separate stream within the user's inbox, or adjacent to the inbox. In some embodiments, the advertisement displayed can be adjacent to the stream within the user's inbox.

The stream engine 408 further generates “calls to action” within the stream. These actions are based on the categorization of the message. As illustrated in FIG. 6A, the “calls to action” 604a, 604b, 604c provide the user with actions the recipient can perform responsive to the message. For example, since the message 602 illustrated in FIG. 6A was categorized as “Personal,” appropriate calls to action involve “reading more” (or the rest of the message—opening the message) 604a, replaying to the message 604b, or forwarding the message 604c.

In another example, references is made to FIG. 6B. In inbox 600, message 650 was categorized as “Travel.” As discussed above, the categorization is based upon the learning engine's 402 knowledge that messages from airlines, i.e., JetBlue® relate to “Travel”. As displayed, the message 650 is displayed as a stream including the sender's identity 651a, title of the message 651b, and the extracted relevant content 652. As discussed above, the extracted content is extracted via the application of the data extraction engine 406 disclosed in Step 510. Additionally, the stream for message 650 includes call to action 654a. The calls to action are based on the type of category of the message. Here, since this message was categorized as “Travel,” the call to action includes an ability to “check-in”. This action 654a could provide a re-directed URL link to the JetBlue travel site so that the recipient can check-in to his/her flight. In Step 514, the stream generated in Step 512 is displayed in the user's inbox, as illustrated in FIGS. 6A-6B.

As further depicted in FIG. 6A, messages that are of lower relevance to a user can be de-emphasized in the inbox. An example of such de-emphasis is that the messages of lower relevance or importance to a user may occupy a smaller amount of space within the inbox. For example, “Personal” message 602 is of higher importance to James than “Travel” email 606 and “Coupon” email 608. In a similar manner, in FIG. 6B illustrates an embodiment where a “Travel” email 650 is of higher relevance to the user than “Coupon” message 660. Such reasoning could be that Travel itineraries are more important than a chance to “purchase a 2 day scuba course at 50% off” as illustrated in item 660.

Additionally, in some embodiments, emails of higher importance can occupy a larger and/or higher profile space within the user's inbox. As illustrated in FIG. 6A, “Personal” message 602 is of higher importance to “Travel” email 606, therefore message 602 is displayed as a larger stream within the user's inbox 600.

Therefore, as an overview of the process of FIG. 5, the messaging engine reviews every incoming email message (Step 502), and categorizes the messages into categories (Step 504), such as, but not limited to, “Personal,” “Shopping,” “Social,” “Finance,” “Travel.” Next, in Steps 506-510, the message is further analyzed and structured data extraction is performed on the message by applying categorically associated templates to the message to extract information relevant to the user from the email. For example, for a message categorized as “Shopping” data related to: “Item Name, Pricing, Sale expiration date, Discount” can be extracted. This extracted information is used in generating the “stream” view (Steps 512-514) to ensure that the message is represented with “enough” and “relevant” information. The disclosed systems and methods rely upon and implement learning algorithms to do real time categorization and extraction, as discussed above. Regarding the streams' calls to action, they are unique and novel and based upon the email category and message type. Therefore, a different call to action is included (or added to) the stream for each category of message. For example, for a “Personal” email, the call to action allows the recipient to “reply”. For a “Travel” email, the call to action can allow the user to “Check-in” to a flight. In another example, as illustrated in FIG. 6B, for an email 660 categorized as “Coupon” (from Groupon®, for example), the call to action 660a (e.g., “buy now”) can allow the user to “purchase” the coupon (or deal) directly from the stream.

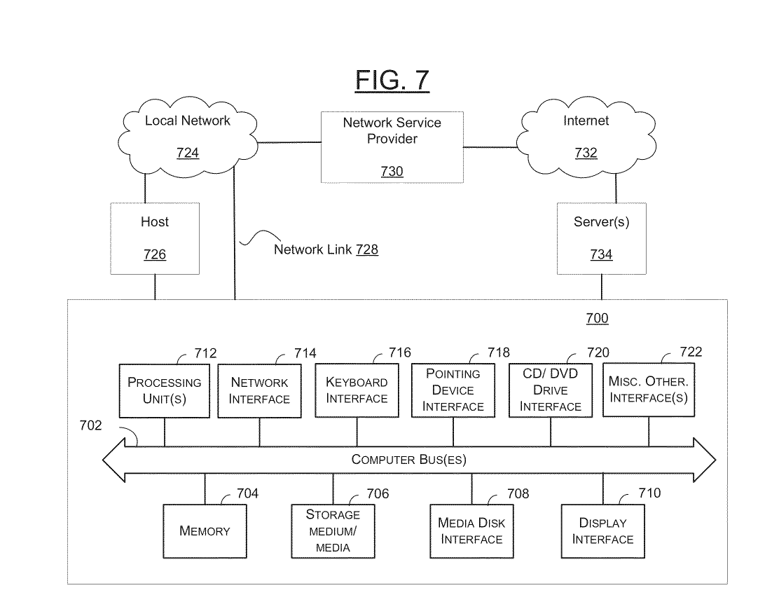

As shown in FIG. 7, internal architecture 700 includes one or more processing units, processors, or processing cores, (also referred to herein as CPUs) 712, which interface with at least one computer bus 702. Also interfacing with computer bus 702 are computer-readable medium, or media, 706, network interface 714, memory 704, e.g., random access memory (RAM), run-time transient memory, read only memory (ROM), media disk drive interface 720 as an interface for a drive that can read and/or write to media including removable media such as floppy, CD-ROM, DVD, media, display interface 710 as interface for a monitor or other display device, keyboard interface 716 as interface for a keyboard, pointing device interface 718 as an interface for a mouse or other pointing device, and miscellaneous other interfaces not shown individually, such as parallel and serial port interfaces and a universal serial bus (USB) interface.

Memory 704 interfaces with computer bus 702 so as to provide information stored in memory 704 to CPU 712 during execution of software programs such as an operating system, application programs, device drivers, and software modules that comprise program code, and/or computer executable process steps, incorporating functionality described herein, e.g., one or more of process flows described herein. CPU 712 first loads computer executable process steps from storage, e.g., memory 704, computer readable storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

Persistent storage, e.g., medium/media 706, can be used to store an operating system and one or more application programs. Persistent storage can also be used to store device drivers, such as one or more of a digital camera driver, monitor driver, printer driver, scanner driver, or other device drivers, web pages, content files, playlists and other files. Persistent storage can further include program modules and data files used to implement one or more embodiments of the present disclosure, e.g., listing selection module(s), targeting information collection module(s), and listing notification module(s), the functionality and use of which in the implementation of the present disclosure are discussed in detail herein.

Network link 728 typically provides information communication using transmission media through one or more networks to other devices that use or process the information. For example, network link 728 may provide a connection through local network 724 to a host computer 726 or to equipment operated by a Network or Internet Service Provider (ISP) 730. ISP equipment in turn provides data communication services through the public, worldwide packet-switching communication network of networks now commonly referred to as the Internet 732.

A computer called a server host 734 connected to the Internet 732 hosts a process that provides a service in response to information received over the Internet 732. For example, server host 734 hosts a process that provides information representing video data for presentation at display 710. It is contemplated that the components of system 700 can be deployed in various configurations within other computer systems, e.g., host and server.

At least some embodiments of the present disclosure are related to the use of computer system 700 for implementing some or all of the techniques described herein. According to one embodiment, those techniques are performed by computer system 700 in response to processing unit 712 executing one or more sequences of one or more processor instructions contained in memory 704. Such instructions, also called computer instructions, software and program code, may be read into memory 704 from another computer-readable medium 706 such as storage device or network link. Execution of the sequences of instructions contained in memory 704 causes processing unit 712 to perform one or more of the method steps described herein. In alternative embodiments, hardware, such as ASIC, may be used in place of or in combination with software. Thus, embodiments of the present disclosure are not limited to any specific combination of hardware and software, unless otherwise explicitly stated herein.

The signals transmitted over network link and other networks through communications interface, carry information to and from computer system 700. Computer system 700 can send and receive information, including program code, through the networks, among others, through network link and communications interface. In an example using the Internet, a server host transmits program code for a particular application, requested by a message sent from computer, through Internet, ISP equipment, local network and communications interface. The received code may be executed by processor 702 as it is received, or may be stored in memory 704 or in storage device or other non-volatile storage for later execution, or both.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, at a computing device over a network, a message from a first user addressed to a second user, said message comprising content and message metadata;
parsing, via the computing device, the message metadata to extract an identifier associated with the first user;
categorizing, via the computing device, the message based on the first user identifier, said categorizing comprising determining a message category corresponding to a message type associated with the first user identifier;
determining, via the computing device, a message template associated with said message category, said message template comprising information for identifying relevant portions of said message type;
comparing, via the computing device, the message template to the message content, said comparing comprising identifying first content from the message content based on said information in the message template;
extracting, via the computing device, said first content from said message content; and
facilitating, via the computing device, display of said first content in an inbox associated with the second user.

2. The method of claim 1, wherein said categorizing further comprises:
selecting said message category from a plurality of message categories corresponding to a plurality of message types that are associated with a plurality of identifiers.

3. The method of claim 2, wherein said plurality of message categories are determined based on message activity respective a message platform, wherein said message activity is continuously monitored to determine updated listings of said plurality of identifiers and associated message categories.

4. The method of claim 1, further comprising:
searching a user profile of said second user to determine whether said first user identifier is identified within said profile,
wherein if said first user identifier is located within said profile, categorizing the message according to a designation in the second user's profile; and
wherein if said first user identifier is absent from said profile, categorizing the message based on said monitoring.

5. The method of claim 1, wherein said message template information comprises a message format for said message category, said message format identifying the relevant portions of the message type.

6. The method of claim 5, further comprising:
identifying said first content within said message that corresponds to said relevant portions of the message type based on said message format.

7. The method of claim 1, wherein the first user identifier is an email address associated with the first user.

8. The method of claim 7, further comprising:
categorizing said message based on a domain of the first user's email address, wherein said message category is associated with at least said domain of the first user's email address.

9. The method of claim 2, further comprising:
facilitating said display of said first content based on the message category, wherein said first content is organized within said inbox based on a priority associated with said message category respective said plurality of message categories, wherein said priority is determined based on said plurality of identifiers.

10. The method of claim 2, wherein said first content comprises functionality specific to said message category which is actionable upon display in said inbox, wherein each of said plurality of message categories are associated with specific functionality actionable upon display in said inbox.

11. The method of claim 1, wherein said message is an email.

12. The method of claim 1, further comprising:
selecting an advertisement based on first content, wherein said facilitated display comprises display of said advertisement in association with said first content.

13. A non-transitory computer-readable storage medium tangibly encoded with computer-executable instructions, that when executed by a computing device, perform a method comprising:
receiving a message from a first user addressed to a second user, said message comprising content and message metadata;
parsing the message metadata to extract an identifier associated with the first user;
categorizing the message based on the first user identifier, said categorizing comprising determining a message category corresponding to a message type associated with the first user identifier;
determining a message template associated with said message category, said message template comprising information for identifying relevant portions of said message type;
comparing the message template to the message content, said comparing comprising identifying first content from the message content based on said information in the message template;
extracting said first content from said message content; and
facilitating display of said first content in an inbox associated with the second user.

14. The non-transitory computer-readable storage medium of claim 13, wherein said categorizing further comprises:
selecting said message category from a plurality of message categories corresponding to a plurality of message types that are associated with a plurality of identifiers.

15. The non-transitory computer-readable storage medium of claim 14, wherein said plurality of message categories are determined based on message activity respective a message platform, wherein said message activity is continuously monitored to determine updated listings of said plurality of identifiers and associated message categories.

16. The non-transitory computer-readable storage medium of claim 13, further comprising:
searching a user profile of said second user to determine whether said first user identifier is identified within said profile,
wherein if said first user identifier is located within said profile, categorizing the message according to a designation in the second user's profile; and
wherein if said first user identifier is absent from said profile, categorizing the message based on said monitoring.

17. The non-transitory computer-readable storage medium of claim 17, further comprising:
identifying said first content within said message that corresponds to said relevant portions of the message type based on said message format.

18. The non-transitory computer-readable storage medium of claim 14, further comprising:
facilitating said display of said first content based on the message category, wherein said first content is organized within said inbox based on a priority associated with said message category respective said plurality of message categories, wherein said priority is determined based on said plurality of identifiers.

19. The non-transitory computer-readable storage medium of claim 14, wherein said first content comprises functionality specific to said message category which is actionable upon display in said inbox, wherein each of said plurality of message categories are associated with specific functionality actionable upon display in said inbox.

20. A system comprising:
at least one computing device comprising:
memory storing computer-executable instructions; and
one or more processors for executing said computer-executable instructions, comprising:
receiving a message from a first user addressed to a second user, said message comprising content and message metadata;
parsing the message metadata to extract an identifier associated with the first user;
categorizing the message based on the first user identifier, said categorizing comprising determining a message category corresponding to a message type associated with the first user identifier;
determining a message template associated with said message category, said message template comprising information for identifying relevant portions of said message type;
comparing the message template to the message content, said comparing comprising identifying first content from the message content based on said information in the message template;
extracting said first content from said message content; and
facilitating display of said first content in an inbox associated with the second user.
